(19) United States
(12) Patent Application Publication
(10) Pub. No.: US 2012/0323950 A1
(43) Pub. Date: Dec. 20, 2012

(54) EMBEDDED QUERY FORMULATION SERVICE

(75) Inventors: Adam D. Wilson, Seattle, WA (US); Christian Liensberger, Bellevue, WA (US)

(73) Assignee: MICROSOFT CORPORATION, Redmond, WA (US)

(21) Appl. No.: 13/162,053

(22) Filed: Jun. 16, 2011

(51) Int. Cl. G06F 17/30

(52) U.S. Cl. 707/766; 707/E17.074

(57) ABSTRACT

Systems and methods for providing and utilizing a query formulation service are described herein. In accordance with certain embodiments, an application is configured to obtain data from a target data source by interacting with a data service that makes data from a plurality of data sources available, each data source supporting a different method of query formulation. To obtain data from the target data source, the application requests a query formulation user interface (UI) associated with the target data source from a query formulation service and embeds the requested query formulation UI when it is received from the query formulation service. A user of the application then interacts with the embedded query formulation UI to formulate a query that is suitable for obtaining data from the target data source and the application sends the query to the data service for execution against the target data source.

### BACKGROUND

Data services exist that allow information workers to access data from a variety of different data sources, such as a variety of different databases and Web services. Access to this data is usually provided through an application, which may enable a user thereof to formulate a query to be executed against a target data source, import data from the target data source, and perform additional actions on data imported from the target data source, such as analysis, visualization or reporting.

The various data sources made available by a data service may support different methods of query formulation and may have disparate capabilities and mechanisms for specifying queries. For example, some data providers may allow users to specify values for fixed parameters as part of formulating a query to be executed against their data sources. Other data providers may allow users to construct flexible SQL-like query expressions. Still other data providers may allow users to craft natural language queries which are then interpreted by the data providers.

Since the various data sources may support different query formulation methods, developers of applications that access such data sources face a difficult and complicated task in building complete and enduring query formulation user interfaces (UIs) that match the intent and fidelity of those allowed by underlying data providers. For example, every time a new data source is made available to an application via the data service, the query formulation UI of the application may need to be updated to support a particular query formulation method supported by the new data source. Furthermore, data providers may modify or augment the query formulation methods supported by their data sources from time to time. In this case, application developers must continuously take steps to ensure that the query formulation UIs built into their applications can take advantage of, or are at least compatible with, the modified or augmented query formulation methods.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

Systems and methods for providing and utilizing a query formulation service are described herein. In accordance with certain embodiments, an application is configured to obtain data from a target data source by interacting with a data service that makes data from a plurality of data sources available, each data source supporting a different method of query formulation. To obtain the data from the target data source, the application requests a query formulation UI associated with the target data source from a query formulation service and embeds the requested query formulation UI within a UI of the application when it is received from the query formulation service. A user of the application then interacts with the embedded query formulation UI to formulate a query that is suitable for obtaining data from the target data source and the application sends the query to the data service for execution against the target data source.

In particular, a system is described herein that includes a data service and a query formulation service, each of which executes on one or more server computers. The data service makes data from a plurality of data sources available to a plurality of applications accessible by users of respective client computers, each data source supporting a different method of query formulation. The data service makes such data available by applying queries received from such applications to the data sources. The query formulation service provides a query formulation UI corresponding to a particular data source in the plurality of data sources for embedding within a particular application in the plurality of applications responsive to receiving a request therefor. The query formulation UI is useable by a user of the particular application to formulate a query that can be submitted by the particular application to the data service to obtain data from the particular data source.

A method of providing a query formulation service is also described herein. In accordance with the method, a request for a query formulation UI to be embedded within an application is received. The query formulation UI is associated with a particular data source in a plurality of data sources and is useable by a user of the application to formulate a query that is suitable for obtaining data from the particular data source. The requested query formulation UI is then obtained from among a plurality of query formulation UIs, each of the plurality of query formulation UIs corresponding to a respective one of the plurality of data sources. The requested query formulation UI is then returned for embedding in the application.

A method of utilizing a query formulation service is also described herein. In accordance with the method, a request is sent to a query formulation service for a query formulation UI associated with a particular data source in a plurality of data sources. The requested query formulation UI is one of a plurality of query formulation UIs, each of the plurality of query formulation UIs corresponding to a respective one of the plurality of data sources. The requested query formulation UI is then received from the query formulation service and embedded within an application to produce an embedded query formulation UI that is useable by a user of the application to formulate a query that is suitable for obtaining data from the particular data source.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of an example system for providing and utilizing a query formulation service in accordance with an embodiment.

FIG. 2 is a block diagram that illustrates a flow of information between system components in one embodiment in which a Web application embeds a query formulation user interface (UI) provided by a query formulation service.

FIG. 3 is a block diagram that illustrates a flow of information between system components in another embodiment in which a Web application embeds a query formulation UI provided by a query formulation service.

FIG. 4 is a block diagram that illustrates a flow of information between system components in an embodiment in which a client application embeds a query formulation UI provided by a query formulation service.

FIG. 5 depicts a flowchart of a method for providing a query formulation service in accordance with an embodiment.

FIG. 6 depicts a flowchart of a method for utilizing a query formulation service in accordance with an embodiment.

FIG. 7 is a block diagram of an example computer system that may be used to implement various embodiments described herein.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Systems and methods for providing and utilizing a query formulation service are described herein. In accordance with certain embodiments, an application is configured to obtain data from a target data source by interacting with a data service that makes data from a plurality of data sources available, each data source supporting a different method of query formulation. To obtain the data from the target data source, the application requests a query formulation UI associated with the target data source from a query formulation service and embeds the requested query formulation UI when it is received from the query formulation service. A user of the application then interacts with the embedded query formulation UI to formulate a query that is suitable for obtaining data from the target data source and the application sends the query to the data service for execution against the target data source.

Since the query formulation service and not the application is responsible for providing the appropriate UI for formulating a query to be executed against a particular data source in the aforementioned embodiments, the developer of the application need not invest any resources in developing a UI for formulating queries to be executed against the data source and can instead rely on the query formulation service to provide such a UI. Furthermore, in embodiments in which the query formulation service provides a variety of query formulation UIs corresponding to a variety of data sources that support different query formulation methods, an application capable of invoking the query formulation service can be easily extended to support the formulation of queries that may be executed against any of the data sources, regardless of the fact that the data sources support different query formulation methods.

As will also be described herein, a query formulation service in accordance with at least one embodiment can advantageously be used to provide new query formulation UIs associated with new data sources as soon as such new data sources become available and also to provide an application with a most recent or up-to-date version of a query formulation UI associated with a particular data source. In accordance with further embodiments to be described herein, a query formulation service can provide a particular version of a query formulation UI to an application. For example, a particular version of a query formulation UI may be requested by or provided to an application by the query formulation service to ensure that the query formulation UI that is returned to the application will be compatible therewith.

In accordance with still further embodiments to be described herein, means are provided by which a data provider associated with a data source can extend and/or customize a query formulation UI provided by the query formulation service for formulating queries to be executed against the data source. Other means may also be provided by which a developer of an application can customize how a query formulation UI provided by the query formulation service is displayed within the application. For example, the means may enable the developer to change the size or style of text boxes or other controls provided by the query formulation UI to better match those of the application.

### II. Example Systems for Providing and Utilizing a Query Formulation Service

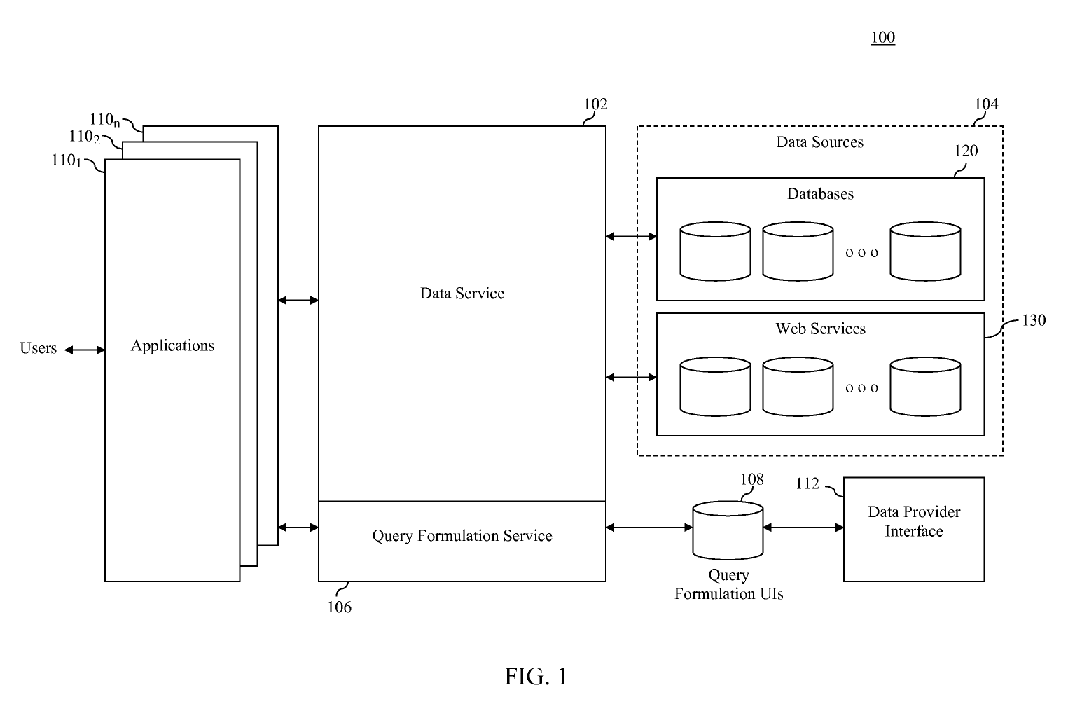

FIG. 1 is a block diagram of an example system 100 for providing and utilizing a query formulation service in accordance with an embodiment. As shown in FIG. 1, system 100 includes a data service 102 that is communicatively connected to a plurality of applications 110₁-110ₙ and to a plurality of data sources 104. As further shown in FIG. 1, system 100 also includes a query formulation service 106 that is communicatively connected to applications 110₁-110ₙ and to a database 108 that stores a plurality of query formulation user interfaces (UIs). As still further shown in FIG. 1, system 100 also includes a data provider interface 112 that is communicatively connected to query formulation service 106.

Data service 102 represents an automated system that makes data from disparate data sources 104 available to applications within plurality of applications 110₁-110ₙ. In one embodiment, data service 102 comprises a service such as Windows Azure™ Marketplace DataMarket, published by Microsoft Corporation of Redmond, Wash. As will be appreciated by persons skilled in the relevant art(s), Windows Azure™ Marketplace DataMarket is a cloud-based service that provides a global marketplace for information including data, Web services and analytics. This service can be utilized by data providers to make their data sources available to a wide audience around the world, by subscribers to locate a data source that addresses their needs through rich discovery, and by developers that can write code to consume the data sources on one or more computing platforms. However, the foregoing is only an example, and data service 102 is intended to broadly represent any service by which applications can obtain data from a plurality of disparate data sources.

In at least one embodiment, the functionality of data service 102 is implemented in software executing on one or more server computers. An example of a computer system that may be used to implement some or all of the features of data service 102 is provided below in Section IV.

Data sources 104 include at least a plurality of databases 120 and a plurality of Web services 130. Each database in plurality of databases 120 comprises an organized collection of data stored in digital form. The manner in which data is organized in each database will correspond to a data model used to implement the database. Common database models include, but are not limited to, hierarchical, network, relational, entity-relationship, object, and object-relational data models. Each database may be stored in one or more memory devices that are communicatively connected to a computer that executes all or a portion of data service 102.

Web services 130 comprise automated systems that operate to provide one or more services to or perform one or more operations on behalf of another automated entity, such as data service 102. In the context of system 100, each Web service in plurality of Web services 130 operates to return a certain type of data to data service 102 in response to receiving a request therefrom. Interaction between data service 102 and each of Web services 130 may be carried out using any well-known Web services protocol, including but not limited to the REST (Representational State Transfer) protocol and the SOAP (Simple Object Access Protocol) protocol. Each Web service may execute on one or more computers that are communicatively connected to a computer that executes all or a portion of data service 102. Alternatively, it is possible that one or more of Web services 130 may execute on a computer that is also used to execute all or a portion of data service 102.

Data service 102 operates to make data from data sources 104 available to applications 110₁-110ₙ by applying queries received from applications 110₁-110ₙ to corresponding data sources. In accordance with an embodiment, different data sources from among data sources 104 support different methods of query formulation. For example, some of data sources 104 may support queries that have been formulated by specifying values for fixed parameters. Other ones of data sources 104 may support queries that have been constructed using flexible SQL-like query expressions. Still other ones of data sources 104 may support queries crafted using natural language query expressions. The type of query formulation supported by a particular data source may be dictated at least in part by the underlying structure or technical capabilities of the data source. Additionally, the type of query formulation supported by a particular data source may also be dictated at least in part by data service 102, which may enforce query formulation rules with respect to certain data sources for reasons relating to system performance or the like.

Applications 110₁-110ₙ comprise executing software applications or processes that are accessible to users of client computers and that include functionality that enable such users to import or otherwise obtain data from one or more of data sources 104 via data service 102. To achieve this, each of applications 110₁-110ₙ is capable of submitting a query formulated by a user thereof to data service 102 for execution against a particular one of data sources 104. As will be discussed in more detail below, one or more of applications 110₁-110ₙ may comprise a Web application that is executed on a Web server and is accessed by a client computer via one or more network(s). An example of a computer system that may be used to implement such a Web server is provided below in Section IV. Additionally or alternatively, one or more of applications 110₁-110ₙ may comprise a client application that is executed on a client computer.

As used herein, the term “client computer” is intended to encompass any system or device that is capable of accessing the functionality of one or more of applications 110₁-110ₙ. Such client computers may include, by way of example only and without limitation, desktop computers, laptop computers, tablet computers, smart phones, personal digital assistants, video gaming consoles, personal media players, or the like. One example of a computer system that may be used to implement a client computer is provided below in Section IV.

To enable a user to formulate a query for submission to data service 102 for execution against a particular one of data sources 104, each of applications 110₁-110ₙ is operable to request a query formulation UI from query formulation service 106 that is suitable for use in constructing a query that can be executed against the targeted data source. Query formulation service 106 comprises an automated system that operates to return an appropriate query formulation UI in response to receiving such requests from applications 110₁-110ₙ. Like data service 102, query formulation service 106 may be implemented in software executing on one or more server computers. In one embodiment, query formulation service 106 is owned and operated by the same entity that owns and operates data service 102, although this need not be the case. In accordance with such an embodiment, data service 102 and query formulation service 106 may be implemented on the same computer or set of computers.

In the embodiment shown in FIG. 1, the query formulation UIs that are used to formulate queries to be executed against the disparate data sources 104 and that may be returned to each of applications 110₁-110ₙ are stored in a database 108 that is communicatively connected to query formulation service 106 and is accessible thereto. In one embodiment, database 108 is stored in one or more memory devices that are communicatively connected to a computer that executes all or a portion of query formulation service 106.

In one embodiment, each query formulation UI is represented and stored as one or more markup language documents or files that can be returned to each application 110₁-110ₙ and rendered thereby for display to a user. Example markup languages that may be utilized to represent the query formulation UIs may include but are not limited to XML, XAML, HTML, or the like. However, the query formulation UIs need not be represented using a markup language and other methods of representing such UIs may be used. For example, in accordance with an alternate embodiment, one or more of the query formulation UIs are dynamically generated by query formulation service 106 based on characteristics of the underlying data source(s) with which the query formulation UI(s) are associated. The characteristics of the underlying data sources may be represented as metadata that is stored by data service 102 or by the data sources themselves and retrieved therefrom.

When an application 110₁-110ₙ receives a requested query formulation UI from query formulation service 106, it embeds such UI within its array of application features thus making the UI available to the user of the application. Various mechanisms by which an application 110₁-110ₙ can embed a query formulation UI will be described below. The query formulation UI that is embedded by the application may provide the user thereof with access to a variety of functions that facilitate the constructing of a query appropriate for a particular data source, such as query validation, preview and other business logic. A user interacts with the embedded query formulation UI to generate a query that the application then submits to data service 102 to be executed against the particular data source.

In certain embodiments, communication between data service 102 and data sources 104, between applications 110₁-110ₙ and data service 102, between applications 110₁-110ₙ and query formulation service 106, and/or between query formulation service 106 and database 108 is carried out over a network or combination of networks. Such network(s) may include, for example, the Internet. However, this example is not intended to be limiting, and communication between such entities may be carried out over any type of network or combination of networks including one or more wide area networks (WANs), local area networks (LANs), private networks, public networks, packet networks, circuit-switched networks, and wired or wireless networks. Although data service 102 and query formulation service 106 are shown as being connected in FIG. 1, it is noted that this need not be the case. Furthermore, in alternate embodiments, each data source shown in FIG. 1 may have its own data service as opposed to there being a single data service all the data sources.

In accordance with the foregoing description of system 100, since query formulation service 106 is responsible for providing the appropriate UI for formulating a query to be executed against a particular data source, the developers of applications 110₁-110ₙ need not invest any resources in developing a UI for formulating queries to be executed against the particular data source. Furthermore, since query formulation service 106 can provide a variety of query formulation UIs corresponding to a variety of data sources that support different query formulation methods, any application 110₁-110ₙ capable of invoking query formulation service 106 can be easily extended to support the formulation of queries that may be executed against any of the data sources, regardless of the fact that the data sources support different query formulation methods.

In accordance with certain embodiments, query formulation service 106 is capable of providing new query formulation UIs associated with new data sources as soon as such new data sources become available via data service 102. Query formulation service 106 can also provide an application with a most recent or up-to-date version of a query formulation UI associated with a particular data source. In accordance with further embodiments, query formulation service 106 can provide a particular version of a query formulation UI to an application. For example, a particular version of a query formulation UI may be requested by one of applications 110₁-110ₙ and/or provided thereto by query formulation service 106 to ensure that the query formulation UI that is returned to the application will be compatible therewith.

A. Example Information Flows

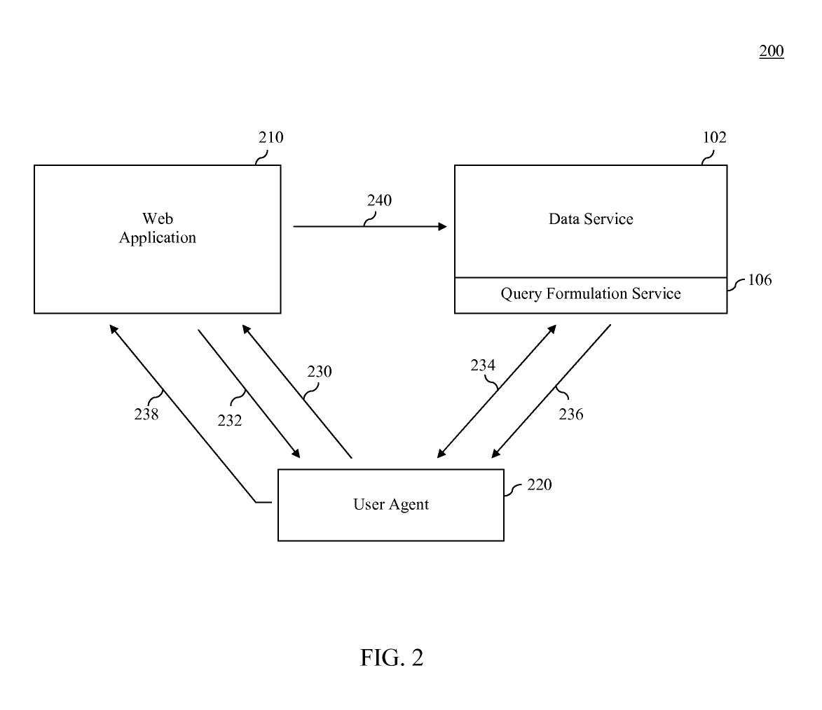

Various information flows will now be described in reference to FIGS. 2-4. Each information flow is intended to illustrate how information may be exchanged between exemplary system components during the provision and utilization of a query formulation service in accordance with an embodiment. These information flows are described herein by way of example only and are not intended to be limiting.

FIG. 2 is a block diagram 200 that illustrates a flow of information between system components in one embodiment in which a Web application embeds a query formulation UI provided by a query formulation service. As shown in FIG. 2, block diagram 200 includes data service 102 and query formulation service 106, each of which was described above in reference to system 100 of FIG. 1. As further shown in FIG. 2, block diagram 200 also includes a Web application 210 and a user agent 220. Web application 210 comprises an application that is accessed over one or more networks by a client computer to deliver functionality to a user of the client computer. Web application 210 may execute on one or more server computers, which may also be referred to as Web servers. Web application 210 may represent a particular one of applications 110₁-110ₙ as described above in reference to system 100 of FIG. 1. User agent 220 comprises a software application or process executing on a client computer that interacts with Web application 210 over one or more networks to deliver the functionality of the Web application to a user of the client computer. In one embodiment, user agent 220 comprises a Web browser, although this is an example only and is not intended to be limiting.

The information flow begins when user agent 220 sends a request to import data to Web application 210, as represented by arrow 230. Such request may be sent by user agent 220, for example, in response to the activation of an import data feature of Web application 210 by a user of user agent 220.

In response to receiving the request to import data, Web application 210 includes HTML markup that instructs user agent 220 to make a subsequent request to query formulation service 106 as represented by arrow 232. In an embodiment in which user agent 220 comprises a Web browser, Web application 210 may perform this function by embedding an iframe inside of a Web page delivered to user agent 220 to which content obtained from query formulation service 106 will be loaded. In another embodiment in which user agent 220 comprises a Web browser, Web application 210 may perform this function by instructing user agent 220 to open up a new browser window and load content obtained from query formulation service 106 into the new browser window. In a still further embodiment in which user agent 220 comprises a Web browser, Web application 210 may perform this function by instructing user agent 220 to obtain content from query formulation service 106 for loading into the entirety of a currently-open browser window (as opposed to the iframe approach described above, in which the content is loaded into only a portion of a currently-open browser window). However, the foregoing approaches are provided by way of example only and other methods may be used to redirect user agent 220 to query formulation service 106.

After user agent 220 has been redirected to query formulation service 106, the user interacts with a query formulation UI provided by query formulation service 106 and rendered by user agent 220 to construct a query to be executed against a target data source. These interactions are denoted by bidirectional arrow 234 in FIG. 2. The query formulation UI that is provided by query formulation service 106 may be adapted to support the construction of queries in a manner consistent with the particular query formulation method or methods supported by the target data source. The query formulation UI may be provided to user agent 220 in the form of one or more markup language documents. For example, in accordance with at least one embodiment, the query formulation UI comprises one or more HTML-defined Web pages that may be delivered to and rendered by user agent 220. However, this represents only one example, and it is to be understood that the query formulation UI may be provided in other forms.

After the user has constructed a query using the query formulation UI provided by query formulation service 106, query formulation service 106 redirects the query back to Web application 210 as represented by arrows 236 and 238 in FIG. 2. Various mechanisms may be used to redirect the query from query formulation service 106 back to Web application 210. For example, in an embodiment in which user agent 220 comprises a Web browser, query formulation service 106 may return an HTML redirect response to user agent 220 wherein the redirect URL includes the query string built using the query formulation UI. In accordance with another example, query formulation service 106 may return JavaScript that invokes a callback function defined by the application or other code to user agent 220 that is executed by user agent 220 to cause the query to be returned to Web application 210. However, these are only examples, and a wide variety of other mechanisms may be used to return the query to Web application 210.

After the query has been returned to Web application 210, Web application 210 provides the query to data service 102 for execution against the data source to which the query is targeted. This is represented by arrow 240. If data is returned from the data source responsive to execution of the query, then data service 102 can provide the returned data to Web application 210 to complete the import data process.

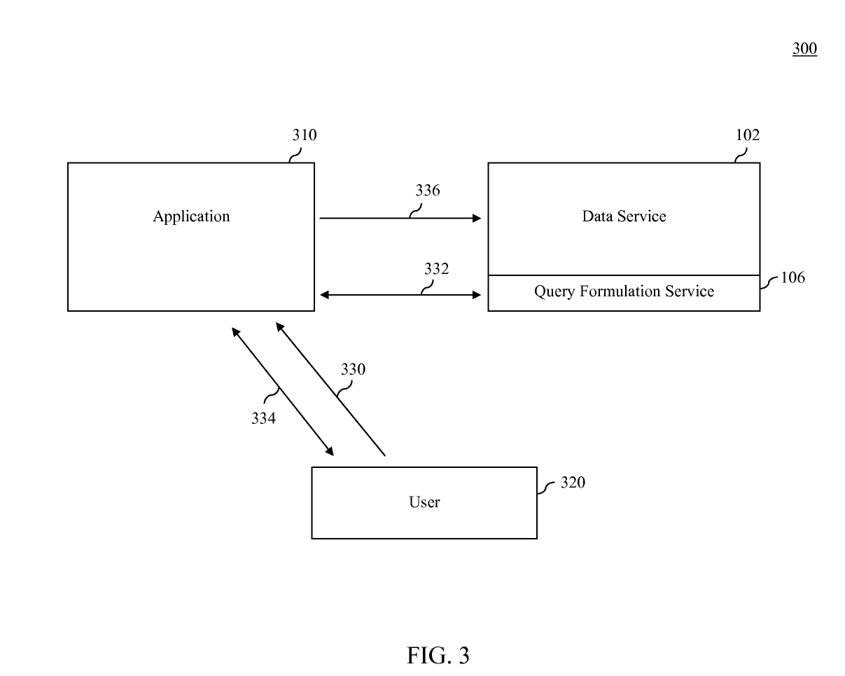

FIG. 3 is a block diagram 300 that illustrates a flow of information between system components in another embodiment in which an application embeds a query formulation UI provided by a query formulation service. As shown in FIG. 3, block diagram 300 includes data service 102 and query formulation service 106, each of which was described above in reference to system 100 of FIG. 1, as well as a user 320. Block diagram 300 also includes an application 310. In an embodiment, application 310 is similar to Web application 210 of FIG. 2 in that it comprises an application that is accessed over one or more networks by a client computer to deliver functionality to a user of the client computer. Alternatively, application 310 may comprise an application that is executed by a client computer to deliver functionality to a local user thereof. In either case, application 310 is configured to act as a proxy to query formulation service 106, translating a query formulation UI provided by query formulation service 106 into content delivered to user 320, rather than relying on redirection of a user agent to query formulation service 106.

This proxy approach will now be explained in the context of the information flow of FIG. 3. The information flow begins when user 320 issues a request to import data to application 310, as represented by arrow 330. Such request may be issued by user 320, for example, via activation of an import data feature of application 310.

In response to receiving the request to import data, application 310 communicates directly with query formulation service 106 to obtain a query formulation UI that corresponds to the data source from which data is to be imported. Application 310 receives the query formulation UI and may provide it to user 320 or, alternatively, translate it to another format, for example to a different markup language, UI description language, or code execution to generate an appropriate UI for user 320. The interaction of the user with the query formulation UI that is proxied by application 310 in this fashion to build a query is represented as bidirectional arrows 332 and 334 in FIG. 3.

After user 320 has constructed a query using the query formulation UI provided by query formulation service 106 and proxied by application 310, application 310 obtains the query and provides it to data service 102 for execution against the data source to which the query is targeted. This is represented by arrow 336. If data is returned from the data source responsive to application of the query, then data service 102 can provide the returned data to application 310 to complete the import data process.

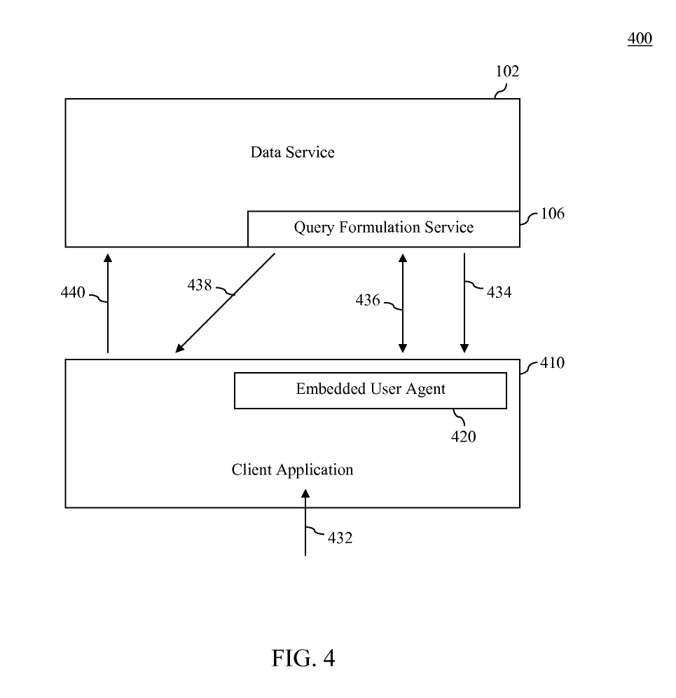

FIG. 4 is a block diagram 400 that illustrates a flow of information between system components in an embodiment in which a client application embeds a query formulation UI provided by a query formulation service. As shown in FIG. 4, block diagram 400 includes data service 102 and query formulation service 106, each of which was described above in reference to system 100 of FIG. 1. As further shown in FIG. 4, block diagram 400 also includes a client application 410. Client application 410 comprises an application that is executed by a client computer to deliver functionality to a user thereof. Client application 410 may represent a particular one of applications 110₁-110ₙ as described above in reference to system 100 of FIG. 1.

As further shown in FIG. 4, client application 410 includes or otherwise has access to an embedded user agent 420. Embedded user agent 220 comprises a software process that is executing on the same client computer as client application 410 and that is capable of interacting with remote entities, such as query formulation service 106, over one or more networks to obtain content therefrom. In one embodiment, embedded user agent 420 comprises an embedded Web browser, although this is an example only and is not intended to be limiting.

The information flow begins when a user of client application activates a feature of client application 410 that is operable to import data from a particular data source made available by data service 102. This is represented as arrow 432 in FIG. 4. In response to the activation of the import data feature, client application 410 utilizes embedded user agent 420 to request an appropriate query formulation UI from query formulation service 106 and to load the query formulation UI when received from query formulation service 106. The loading of the query formulation UI in embedded user agent is represented by arrow 434 in FIG. 2.

Embedded user agent 420 then renders the received query formulation UI in a manner that allows the user of application 410 to interact with the query formulation UI to construct a query to be executed against the target data source. These interactions are denoted by bidirectional arrow 436 in FIG. 4. After the user has constructed a query using the query formulation UI provided by query formulation service 106, query formulation service 106 provides the query to client application 410 as represented by arrow 438. After the query has been returned to client application 410, client application 410 provides the query to data service 102 for execution against the data source to which the query is targeted. This is represented by arrow 440. If data is returned from the data source responsive to execution of the query, then data service 102 can provide the returned data to client application 410 to complete the import data process.

B. Example Query Formulation UI Functionality

As discussed above, a query formulation UI provided by query formulation service 106 may enable a user to construct a query to be executed against a particular data source using a query formulation method that is supported by that data source. This may entail, for example and without limitation, allowing a user to construct a query by entering fixed parameters, allowing a user to construct SQL-like expressions (either in text or graphical form), or allowing a user to view a data source and perform operations such as filters, sorts and selects graphically to generate a query. This may also entail allowing a user to enter a natural language query using any of a variety of input methods (for example, text, gesture, audio, video, or the like). The natural language query could then be translated to a different form by query formulation service 106 or by the data provider associated with the target data source.

The query formulation UI provided by query formulation service 106 may perform other functions as well. For example, the query formulation UI may be operable to present a preview of the results that would be generated by executing a particular query against a particular data source. The query formulation UI may also be operable to provide an estimate of a cost associated with a query created by a user before the user causes the query to be executed against a particular data source. The query formulation UI may also be operable to generate a persistent representation (for example, a URL representation) of a query that is constructed by a user and the results associated therewith so that the representation could be used multiple times by the application. In an embodiment in which a user is charged for obtaining data from data service 102, such a representation could be used multiple times by the application without resulting in more than one charge to the user.

In a still further embodiment, query formulation service 106 may be operable to selectively provide a user with one of a plurality of different query formulation UIs that are usable to build queries for execution against a particular data source. For example, each of the query formulation UIs associated with the particular data source may be of a different level of complexity and/or provide a different set of query-building tools. Query formulation service 106 may select an appropriate one of the query formulation UIs in a manner that is based, for example, on a determined proficiency of the user, on a context in which the query formulation UI is integrated, and/or on a variety of other factors.

C. Query Formulation UI Customization and Augmentation

In accordance with certain embodiments, a data provider associated with a data source made available by data service 102 may be allowed to customize, augment or otherwise modify a query formulation UI that is served by query formulation service 106 in association with that data source. Such customizations and augmentations may include, for example and without limitation, changing the appearance of the query formulation UI or adding, removing or changing functionality and/or features that are accessible via the query formulation UI. In the embodiment shown in FIG. 1, such modifications may be achieved by providing a data provider interface 112 to query formulation service 106 that enables a data provider to provide metadata that defines or otherwise represents such modifications to a query formulation UI. The metadata may be stored, for example, in database 108 or some other location that is accessible to query formulation service 106. The metadata may be stored in association with a particular data source and/or in association with the query formulation UI(s) to which the modifications apply.

In accordance with further embodiments, a data provider associated with a particular data source may dynamically provide all or a portion of a query formulation UI that is requested from query formulation service 106. Such an implementation may be achieved, for example, by configuring query formulation service 106 to issue a callback to a data provider server when a request for the query formulation UI is received. Such an implementation enables a data provider to exercise control over some or all of the remote query formulation UI.

In accordance with still further embodiments, an application may be configured to customize, augment or otherwise modify a query formulation UI that is served by query formulation service 106 in association with that data source. The manner in which the application may be configured to implement such modifications may depend on how they application embeds the query formulation UI. For example, in a system in which the application comprises Web application 210 of FIG. 2, the application does not have direct access to the query formulation UI. In this case, the application must be configured to provide some information to user agent 220 that enables the user agent to load information regarding application-specific modifications to be made to the query formulation UI.

In contrast, in a system in which the application comprises application 310 of FIG. 3 or client application 410 of FIG. 4, the application does have direct access to the query formulation UI and thus can apply modifications directly thereto. Such modifications may include, for example and without limitation, changing the appearance of the query formulation UI or adding, removing or changing functionality and/or features that are accessible via the query formulation UI. Such modifications may also include transforming a query formulation UI from a first representation (e.g., a first markup language representation) to a second representation (e.g., a second markup language representation) to facilitate rendering thereof, or any other type of modification.

### III. Example Methods for Providing and Utilizing a Query Formulation Service

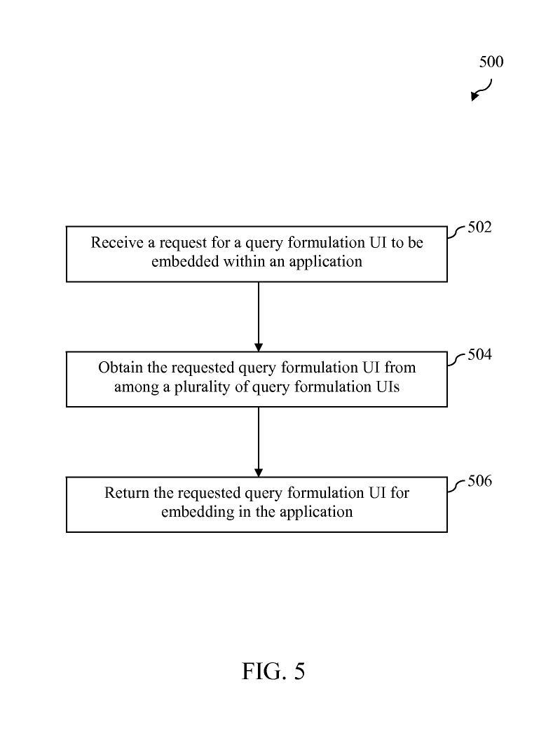

FIG. 5 depicts a flowchart 500 of an exemplary method for utilizing a query formulation service in accordance with an embodiment. The method of flowchart 500 will now be described with continued reference to system 100 as described above in reference to FIG. 1 as well as to various system elements described in reference to the block diagrams of FIGS. 2-4. However, the method is not limited to those embodiments. Persons skilled in the relevant art(s) will readily appreciate that the method of flowchart 500 may be implemented using other systems or system elements.

As shown in FIG. 5, the method of flowchart 500 begins at step 502 in which a request for a query formulation UI to be embedded within an application is received. The query UI may be associated with a particular data source in a plurality of data sources and may be useable by a user of the application to formulate a query that is suitable for obtaining data from the particular data source. This step may be performed, for example, by query formulation service 106 of FIG. 1 which can receive request for a query formulation UI to be embedded within any of applications 110₁-110ₙ as previously described.

Step 502 may comprise, for example, receiving a request for a query formulation UI that is associated with a particular database or a particular Web service. For example, with continued reference to system 100 of FIG. 1, step 502 may comprise receiving a request for a query formulation UI that is associated with a particular one of databases 120 or a particular one of Web services 130 made available by data service 102. The requested query formulation UI may be operable to allow a user to formulate a query in a manner that is supported by the particular database or the particular Web service.

Step 502 may further comprise receiving a request for a query formulation UI to be embedded within a Web application executing on a Web server, such as Web application 210 described above in reference to FIG. 2 or Web application 310 described above in reference to FIG. 3. Step 502 may also comprise receiving a request for a query formulation UI to be embedded within a client application executing on a client computer, such as client application 410 described above in reference to FIG. 4.

At step 504, the requested query formulation UI is obtained from among a plurality of query formulation UIs. This step may be performed, for example, by query formulation service 106 which can obtain the requested query formulation UI from among a plurality of query formulation UIs stored in database 108.

At step 506, the requested query formulation UI is returned for embedding in the application. This step may also be performed, for example, by query formulation service 106 which can return the requested query formulation UI for embedding in any of applications 110₁-110ₙ.

The method of flowchart 500 may further include customizing or controlling at least a portion of the requested query formulation UI by an entity associated with the particular data source. For example, various methods were discussed in Section II.C above by which a data provider associated with a particular data source could customize a query formulation UI or by which a data provider associated with a particular data source could return or all or a portion of a requested query formulation UI to a query formulation service.

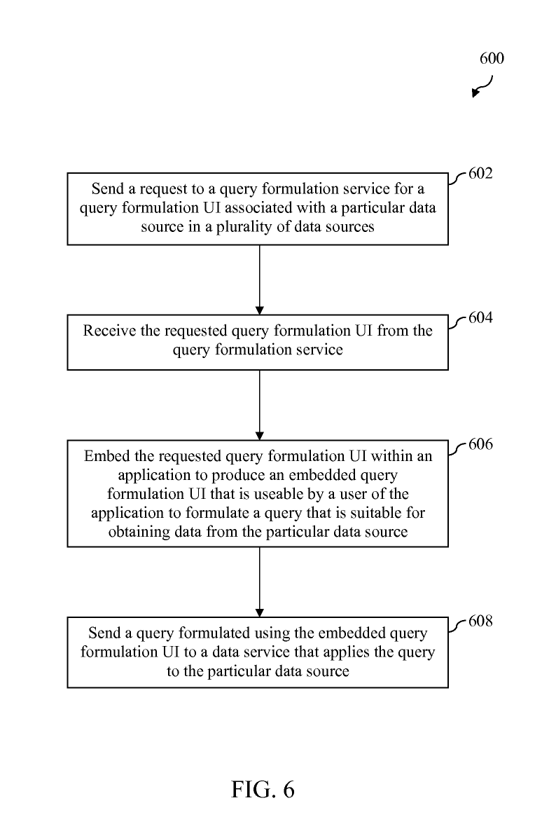

FIG. 6 depicts a flowchart 600 of a method of utilizing a query formulation service in accordance with an embodiment. The method of flowchart 600 will now be described with continued reference to system 100 as described above in reference to FIG. 1 as well as to various system elements described in reference to the block diagrams of FIGS. 2-4. However, the method is not limited to those embodiments. Persons skilled in the relevant art(s) will readily appreciate that the method of flowchart 600 may be implemented using other systems or system elements.

As shown in FIG. 6, the method of flowchart 600 begins at step 602 in which a request is sent to a query formulation service for a query formulation UI associated with a particular data source in a plurality of data sources. The requested query formulation UI may comprise one of a plurality of query formulation UIs, each of which corresponds to a respective one of the plurality of data sources. This step may be performed, for example, by any of applications 110₁-110ₙ of FIG. 1, each of which can send a request for a query formulation UI to query formulation service 106 as previously described.

Step 602 may comprise, for example, sending a request for a query formulation UI that is associated with a particular database or a particular Web service to the query formulation service. For example, with continued reference to system 100 of FIG. 1, step 602 may comprise sending a request for a query formulation UI that is associated with a particular one of databases 120 or a particular one of Web services 130 made available by data service 102 to query formulation service 106. The query formulation UI that is requested may be operable to allow a user to formulate a query in a manner that is supported by the particular database or the particular Web service.

At step 604, the requested query formulation UI is received from the query formulation service. This step may be performed, for example, by any of applications 110₁-110ₙ of FIG. 1, each of which can receive a requested query formulation UI from query formulation service 106 as previously described.

At step 606, the requested query formulation UI is embedded within an application to produce an embedded query formulation UI that is useable by a user of the application to formulate a query that is suitable for obtaining data from the particular data source. This step may be performed, for example, by any of applications 110₁-110ₙ of FIG. 1, each of which can embed a requested query formulation UI received from query formulation service 106 as previously described.

In accordance with certain embodiments, step 606 comprises embedding the requested query formulation UI within a Web application. Various methods by which a requested query formulation UI could be embedded within a Web application were described above in reference to the example information flows of FIGS. 2 and 3. In accordance with certain other embodiments, step 606 comprises embedding the requested query formulation UI within a client application executing on a client computer. Various methods by which a requested query formulation UI could be embedded within a client application executing on a client computer were described above in reference to the example information flow of FIG. 4.

At step 608, the query formulated using the embedded query formulation UI is sent to a data service that applies the query to a particular data source. This step may be performed, for example, by any of applications 110₁-110ₙ of FIG. 1, each of which can send a query formulated using an embedded query formulation UI to data service 102 that applies the query to a particular data source within data sources 104.

The method of flowchart 600 may further include modifying the requested query formulation UI by the application prior to presentation of the requested query formulation UI to a user of the application. Various techniques by which an application may modify a query formulation UI obtained from a query formulation service were described above in Section II.C.

### IV. Example Computer System Implementations

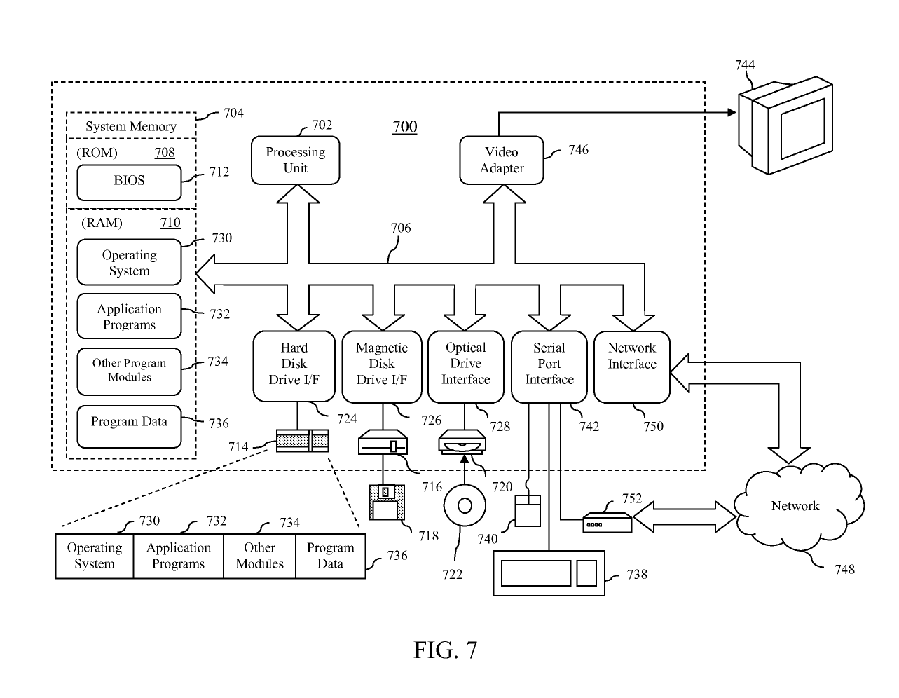

FIG. 7 depicts an example computer system 700 that may be used to implement various embodiments described herein. For example, computer system 700 may be used to implement any of the following previously-described elements: data service 102, query formulation service 106, applications 110₁-110ₙ, data provider interface 112, Web application 210, user agent 220, Web application 310 and client application 410. The description of computer system 700 provided herein is provided for purposes of illustration, and is not intended to be limiting. Embodiments may be implemented in further types of computer systems, as would be known to persons skilled in the relevant art(s).

As shown in FIG. 7, computer system 700 includes a processing unit 702, a system memory 704, and a bus 706 that couples various system components including system memory 704 to processing unit 702. Processing unit 702 may comprise one or more processors or processing cores. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer system 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 730, one or more application programs 732, other program modules 734, and program data 736. In accordance with various embodiments, the program modules may include computer program logic that is executable by processing unit 702 to perform any or all of the functions and features of data service 102, query formulation service 106, applications 110₁-110ₙ, data provider interface 112, Web application 210, user agent 220, Web application 310 and client application 410 as described above in reference to FIGS. 1-4. The program modules may also include computer program logic that, when executed by processing unit 702, performs any of the steps of flowchart 500 of FIG. 5 or flowchart 600 of FIG. 6.

A user may enter commands and information into computer system 700 through input devices such as a keyboard 738 and a pointing device 740. Other input devices (not shown) may include a microphone, joystick, game controller, scanner, or the like. In one embodiment, a touch screen is provided in conjunction with a display 744 to allow a user to provide user input via the application of a touch (as by a finger or stylus for example) to one or more points on the touch screen. These and other input devices are often connected to processing unit 702 through a serial port interface 742 that is coupled to bus 706, but may be connected by other interfaces, such as a parallel port, game port, or a universal serial bus (USB).

A display 744 is also connected to bus 706 via an interface, such as a video adapter 746. In addition to display 744, computer system 700 may include other peripheral output devices (not shown) such as speakers and printers.

Computer system 700 is connected to a network 748 (e.g., a local area network or wide area network such as the Internet) through a network interface or adapter 750, a modem 752, or other means for establishing communications over the network. Modem 752, which may be internal or external, is connected to bus 706 via serial port interface 742.

As used herein, the terms “computer program medium” and “computer-readable medium” are used to generally refer to non-transitory media such as the hard disk associated with hard disk drive 714, removable magnetic disk 718, removable optical disk 722, as well as other media such as flash memory cards, digital video disks, random access memories (RAMs), read only memories (ROM), and the like.

As noted above, computer programs and modules (including application programs 732 and other program modules 734) may be stored on the hard disk, magnetic disk, optical disk, ROM, or RAM. Such computer programs may also be received via network interface 750 or serial port interface 742. Such computer programs, when executed by processing unit 702, enable computer system 700 to implement features of embodiments discussed herein. Accordingly, such computer programs represent controllers of computer system 700.

Embodiments are also directed to computer program products comprising software stored on any computer-readable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

In alternative implementations, each of data service 102, query formulation service 106, applications 110₁-110ₙ, data provider interface 112, Web application 210, user agent 220, Web application 310 and client application 410 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system, comprising:
a data service executing on one or more server computers that makes data from a plurality of data sources available to a plurality of applications accessible by respective client computers by applying queries received from such applications to the data sources, each data source supporting a different method of query formulation; and
a query formulation service executing on the one or more server computers that provides a query formulation user interface (UI) corresponding to a particular data source in the plurality of data sources for embedding within a particular application in the plurality of applications responsive to receiving a request therefor, the query formulation UI being useable by a user of the particular application to formulate a query that can be submitted by the particular application to the data service to obtain data from the particular data source.

2. The system of claim 1, wherein the plurality of data sources includes one or more databases or Web services.

3. The system of claim 1, wherein the plurality of applications includes a Web application executing on a Web server, the Web application being accessible by at least one of the client computers via a network.

4. The system of claim 3, wherein the Web application is operable to load a query formulation UI provided by the query formulation service into one or more Web pages to be delivered to at least one of the client computers via the network.

5. The system of claim 4, wherein the Web application is operable to modify the query formulation UI provided by the embedded query formulation service prior to loading the query formulation UI into the one or more Web pages.

6. The system of claim 3, wherein the Web application is operable to direct a user agent executing on at least one of the client computers to obtain the query formulation UI from the query formulation service.

7. The system of claim 6, wherein the Web application is further operable to direct the user agent to obtain application-specific customizations to the query formulation UI.

8. The system of claim 1, wherein the plurality of applications includes a client application executing on a client computer, the client application including an embedded user agent operable to obtain a query formulation UI from the query formulation service.

9. The system of claim 8, wherein the client application is operable to modify the query formulation UI obtained from the query formulation service prior to presenting the query formulation UI to a user of the client application.

10. The system of claim 1, wherein at least a portion of the query formulation UI provided to the particular application comprises metadata provided by an entity associated with the particular data source, the metadata defining source-specific customizations to the query formulation UI.

11. The system of claim 1, wherein at least a portion of the query formulation UI provided to the particular application is obtained by the query formulation service from a service hosted by an entity associated with the particular data source.

12. A method of providing a query formulation service, comprising:
receiving a request for a query formulation user interface (UI) to be embedded within an application, the query formulation UI being associated with a particular data source in a plurality of data sources and being useable by a user of the application to formulate a query that is suitable for obtaining data from the particular data source;
obtaining the requested query formulation UI from among a plurality of query formulation UIs, each of the plurality of query formulation UIs corresponding to a respective one of the plurality of data sources; and
returning the requested query formulation UI for embedding in the application.

13. The method of claim 12, wherein receiving the request for the query formulation UI comprises:
receiving a request for a query formulation UI associated with a particular database or a particular Web service.

14. The method of claim 12, wherein receiving the request for the query formulation UI to be embedded within the application comprises:
receiving a request for a query formulation UI to be embedded within a Web application executing on a Web server or within a client application executing on a client computer.

15. The method of claim 12, further comprising:
customizing or controlling at least a portion of the requested query formulation UI by an entity associated with the particular data source.

16. A method of utilizing a query formulation service, comprising:
sending a request to the query formulation service for a query formulation user interface (UI) associated with a particular data source in a plurality of data sources, the requested query formulation UI being one of a plurality of query formulation UIs, each of the plurality of query formulation UIs corresponding to a respective one of the plurality of data sources;
receiving the requested query formulation UI from the query formulation service; and
embedding the requested query formulation UI within an application to produce an embedded query formulation UI that is useable by a user of the application to formulate a query that is suitable for obtaining data from the particular data source.

17. The method of claim 16, further comprising:
sending a query formulated using the embedded query formulation UI to a data service that provides access to each of the plurality of data sources.

18. The method of claim 16, wherein sending the request for a query formulation UI associated with a particular data source comprises sending a request for a query formulation UI associated with a particular database or Web service.

19. The method of claim 16, wherein embedding the requested query formulation UI within an application comprises embedding the requested query formulation UI within a Web application executing on a Web server or within a client application executing on a client computer.

20. The method of claim 16, further comprising:
modifying the requested query formulation UI by the application prior to presentation of the requested query formulation UI to a user of the application.
